(19) United States
(12) Patent Application Publication
(10) Pub. No.: US 2009/0327238 A1
(43) Pub. Date: Dec. 31, 2009

(54) EXTENSIBLE BINDING OF DATA WITHIN GRAPHICAL RICH APPLICATIONS

(75) Inventors: Mark J. Leece, Redmond, WA (US); Jevan D. Saks, Redmond, WA (US); Mark J. Finocchio, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/164,031

(22) Filed: Jun. 28, 2008

(51) Int. Cl. G06F 17/30

(52) U.S. Cl. 707/3; 707/E17.014

(57) ABSTRACT

An arrangement is provided for retrieving and updating data within an application, such as a media player application and its metadata. Information is gathered from multiple remote sources. The remote source is queried for information, and information is received from the same. The received information is compared to a number of stored data storage conventions. The particular data storage convention employed is determined, and using the determined data storage convention, data is bound to a number of fields in the application.

### BACKGROUND

As digital media technology improves and the price of storage decreases, users increasingly host collections of digital media, such as music, images, videos, and the like, on their personal computers as well as on portable client devices. And with the advent of relatively high capacity storage on personal computers and portable client devices, users can store large numbers of media files. To administer and manage these media libraries, users employ media player applications which can display the contents of media libraries, both on the personal computer and on portable client devices. Media player applications can also perform a number of other functions, such as ripping media files from CDs and DVDs, organizing playlists, managing transfers between the personal computer and the portable client device, burning CDs and DVDs, and the like.

Despite the significant functionality of media player applications, however, the same generally do not enjoy the richness of experience obtained by users when browsing current digital media stores and social networking sites. In particular, current media player applications generally fall short of the graphic and informational richness of online sites. In addition, online sites enjoy the ability to be updated in real time, unlike media player applications, which generally download updates at some regular interval.

On the other hand, current digital media stores and social networking sites lack the responsiveness, directness, and power found in traditional desktop applications. Moreover, updates to current digital media stores and social networking sites generally do not address revisions of file information, such as updates to metatags such as artist or song names.

### SUMMARY

Arrangements are described which provide users with a unified digital media-centric experience that immerses the user within a larger digital media ecosystem. In some ways, the user experience is a merger of traditional desktop applications, current digital media stores, and social networking sites, because the resultant functionality is drawn from parts of each. The user experience is defined on-line allowing content and new experiences to be delivered post-product-release. The arrangement provides for seamless delivery of new and updated experiences without degradation of responsiveness even where the sources of displayed information are provided remotely.

In one aspect, arrangements provide one or more tangible machine-readable media having a set of machine-readable instructions embodied thereon that when processed by a computing device cause it to perform one or more methods.

One method that may be performed by the arrangement includes a method of gathering information from multiple remote sources, the multiple remote sources collectively employing multiple data storage conventions. Steps of the method include querying a remote source for information and receiving information from the remote source. The received information is compared to a plurality of stored data storage conventions. Another step is to determine which if any of the data storage conventions correspond to the received information, and, using the determined data storage convention, binding the data in the received information to a plurality of fields in an application.

Implementations of the arrangement may include one or more of the following. The information may correspond to metadata about a media file. The binding may be performed when other data in the plurality of fields are not otherwise being accessed. The data storage convention may correspond to a database format, an XML format, or any other format. At least a portion of the querying, receiving, comparing, determining, and binding may be performed by a data provider. The data provider may be a REST-based XML data provider that queries XML data from a REST service, a database data provider that queries database data from a local database, and so on. The method may further include registering and implementing the data provider.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 is a schematic illustration for the arrangement for extensible binding of a client user interface to service data, showing a subject application referencing a framework.

FIG. 2 is a functional schematic illustration of an arrangement for extensible binding of a client user interface to service data, showing data providers implemented for retrieving data from data stores.

FIG. 3 is a flowchart for an arrangement for extensible binding of a client user interface to service data, illustrating the implementation of data providers for retrieving data from data stores.

FIG. 4 shows an exemplary markup schema file.

FIG. 5 shows an exemplary XML data return from an XML data provider.

FIG. 6 shows markup demonstrating how a query can be performed, and how its results bind to user interface elements.

FIG. 7 shows a definition of the IDataProvider method.

FIG. 8 shows a definition of a derived DataProviderQuery instance.

FIG. 9 shows a definition of a DataProviderObject class.

FIG. 10 is a simplified functional block diagram of an exemplary configuration of an operating environment in which the arrangement for extensible binding of a client user interface to service data may be implemented or used.

Corresponding reference characters indicate corresponding parts throughout the drawings.

### DETAILED DESCRIPTION

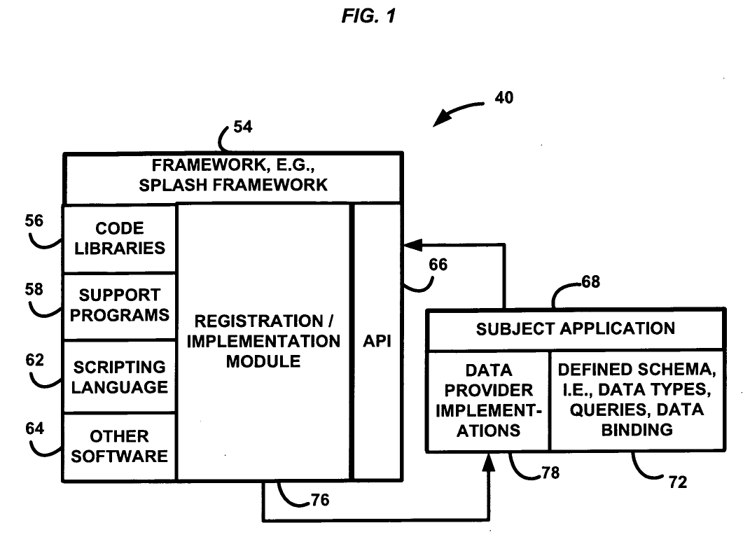

FIGS. 1-9 illustrate how the arrangement may be employed to support the dynamic update of application experiences that present local and remote sources of information. Using the arrangement, the application author, who is writing markup for the framework, e.g., the Splash framework, may be distanced from the acquisition and processing of the data sources.

FIG. 1 illustrates an arrangement 40 in which a framework 54 is employed by a subject application 68, which presents local and remote sources of information that may need to be dynamically updated. In some implementations, the framework 54 is a Splash framework. The framework 54 includes various predefined code that can be called or accessed via an API 66. The framework 54 may also encapsulate commonly shared resources such as code libraries 56, support programs 58, a scripting language module 62, as well as other software 64. The framework 54 is extended by the arrangement to allow data types, queries, and data binding to be defined as schema 72 within the subject application 68. The schematized objects reference data providers 78. The subject application 68 contains one or more data provider implementations 78, and the same are registered and implemented via a registration/implementation module 76.

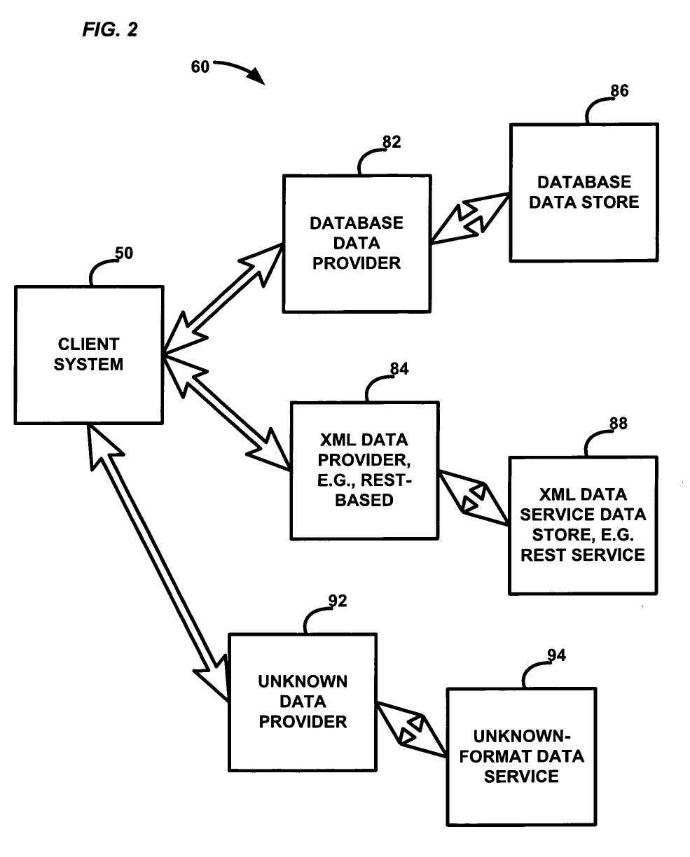

Referring to FIG. 2, a client system 50 registers and implements at least one and generally more data providers. In the figure, three data providers are shown: one for data stored in a database format (database data provider 82), one for data stored in an XML format (XML data provider 84), and one for which the format is unknown (data provider 92). The database data provider 82 may be employed to access and bind data in a database data store 86. The XML data provider 82 may be employed to access and bind data in an XML data store 88. The unknown data provider 92 may be employed to access and bind data in an unknown-format data store 94; however, the same may only perform this action once the data provider 92 has been implemented and registered by the registration/implementation module 76.

For example, the application may implement a generic REST-based XML data provider that queries XML data from a REST service, or a generic database data provider that queries data from a local database. These providers can then be referenced in markup type, query, and data-mapping definitions to perform actual queries, and can then bind their results to visual elements in the user interface.

Following registration and implementation, the schematized objects may reference the data providers. The data types, their data mappings, and queries may be defined in markup schema files.

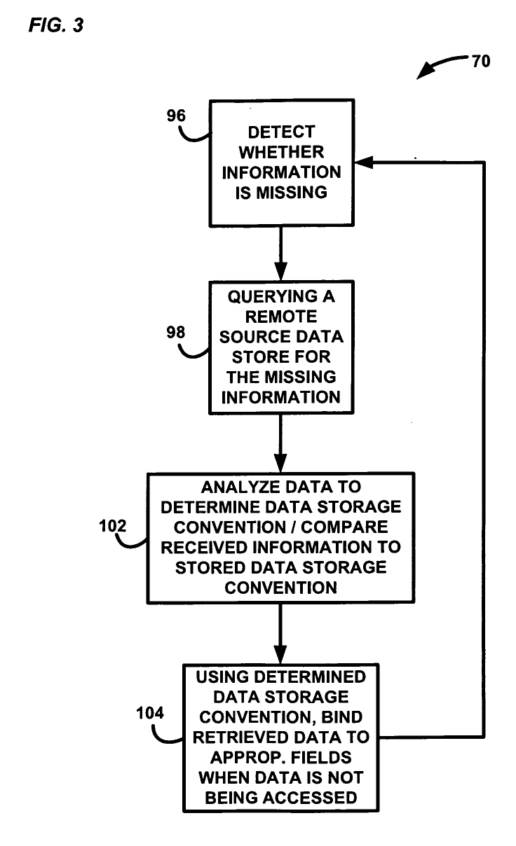

FIG. 3 illustrates a flowchart 70 of the arrangement. A first step is to detect whether information is missing (step 96), e.g., metadata information. This step may be instigated in any number of ways. For example, a check may be made for missing data. In one implementation, the application may periodically audit metadata for missing tags. In another, the query for missing data may be caused when a content item is added to a media library, and a check for missing data may be instigated at that time. Numerous other explicit or implicit triggers may be employed to cause a query to be performed.

A next step is to query a remote source data store for information determined in step 96. As noted above, the information queried may not necessarily be specifically indicated at the time of querying. Rather, a general search for data (within certain defined boundaries) may be caused. Following the query, any data retrieved may be analyzed to determine a data storage convention appertaining to the retrieved data (step 102). For example, a comparison may be made of the data storage convention of the retrieved data to one or more stored data storage conventions. Using the determined data storage convention, the retrieved data may be bound to appropriate fields in the user interface (step 104). The binding may occur when the data is not otherwise being accessed. The process may then repeat.

In a specific example, if a user has two albums, while the application is displaying the songs in a first album, the songs in the second album may be updated in any information that is incomplete in their tags.

For example, if metadata is missing about an album name in a multimedia file for a song, a query may be made of various data stores pertaining to music to attempt to find the missing data, and in this way the information may be updated in a user's media library. As noted above the data store may be an XML data store, a database data store, or may even be unknown. If an unknown-format data store is encountered, the application may attempt to register and implement a new data provider. If the desired data is not obtained from one data store, another data store may be queried. These multiple queries may be performed in serial or even in parallel in some implementations.

For multimedia or other files, algorithms may be employed in additional attempts to determine missing data. Such algorithms may include using retrieved related data to attempt to deduce the missing data. For example, if a data store returns data for a content item, and the returned data is a song title and an artist, an algorithm may attempt to deduce the album title using the same or a different data store. Even if a unique match cannot be made, the algorithm may reduce the number of possibilities to a small number, a unique selection of which may then made by the user. In other implementations, audio file sound recognition software may be employed to calculate the identity of the song and thus what its appertaining metadata should be.

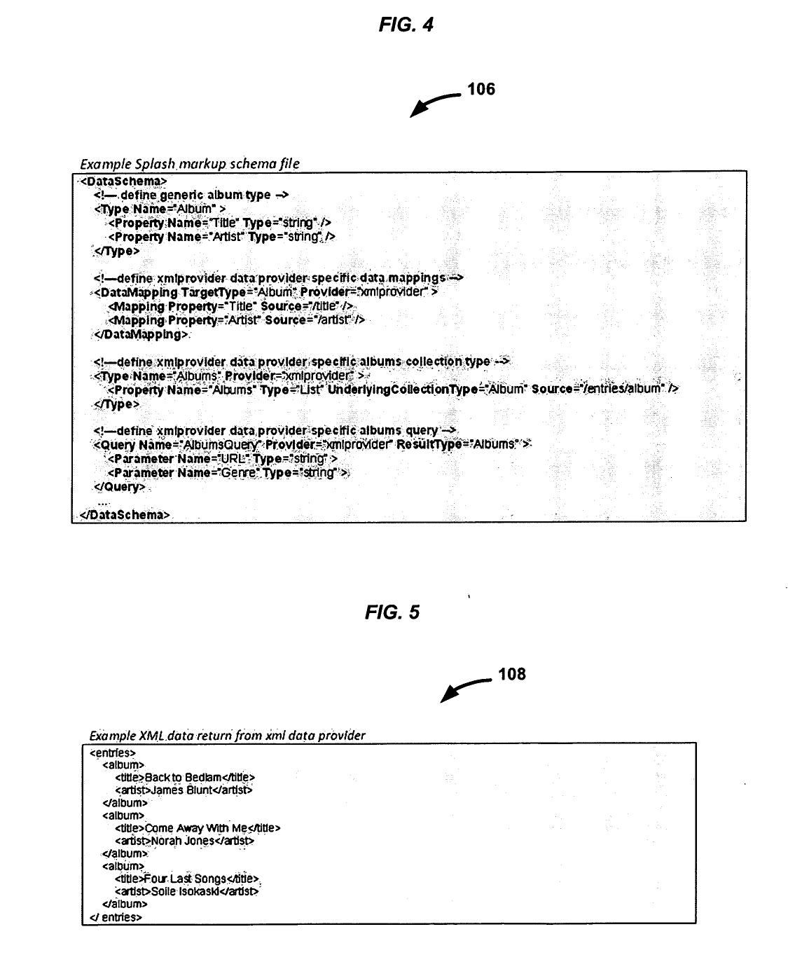

FIGS. 4-9 illustrate various code examples in a specific implementation. FIG. 4 illustrates an exemplary Splash markup schema file for an audio or song file, and an XML data provider may return XML data in the form indicated by FIG. 5. The exemplary schema file defines a generic ‘ALBUM’ type as well as XML-provider-specific mappings that map ‘title’ and ‘artist’ XML elements to the defined ALBUM type's TITLE and ARTIST properties. An XML-provider-specific ALBUMS type is then defined that has an ALBUMS list property whose underlying list item type is ALBUM. Each list item is mapped to ‘/entries/album’ XML elements. An XML-provider-specific query is then defined that takes URL and GENRE parameters.

FIG. 4 also indicates a result of the abstraction noted above, where the application author is distanced from the acquisition and processing of the data sources. A Type definition is described which is processed by the framework and in markup provides a type that is similar or identical in behavior to any other types accessible from markup, i.e., other built-in and user-defined types.

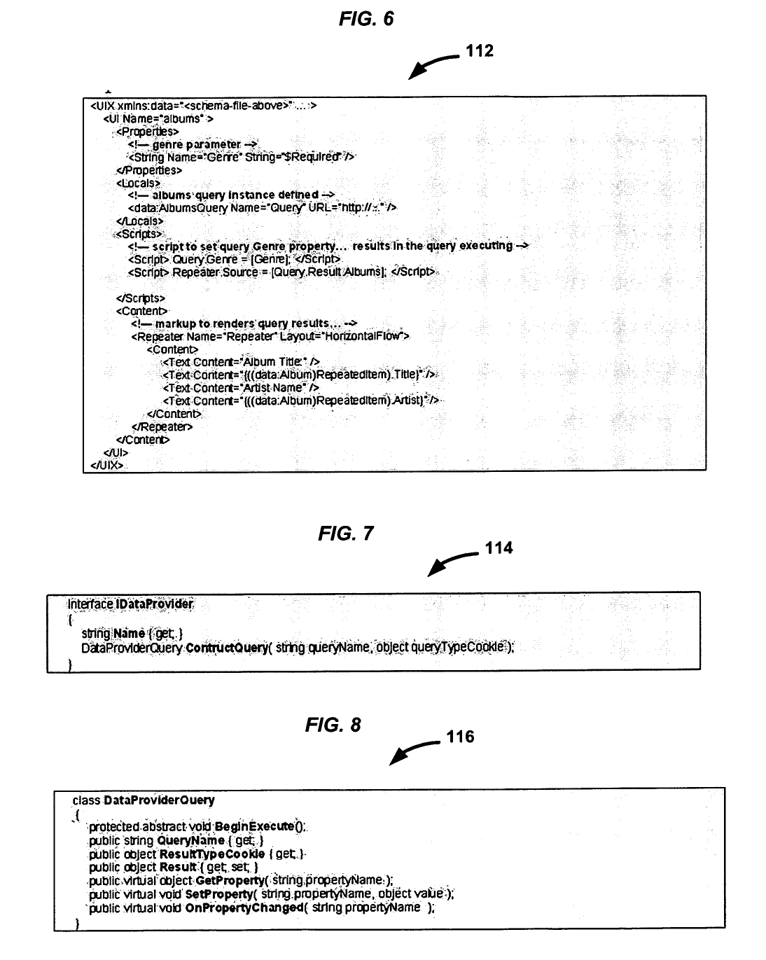

FIG. 6 illustrates how the query can be performed from markup, and how its results bind to elements in the user interface.

As noted above, the application registers the data providers referenced in schema definitions using the Splash framework's RegisterDataProvider(IDataProvider) method, where IDataProvider is as defined in FIG. 7. In that figure, the Name( ) method returns the name of the provider used in schema definitions. The ConstructQuery( . . . ) method in IDataProvider is called when a corresponding markup query object is instantiated by the Splash markup parser.

The implementations return a derived DataProviderQuery instance which is defined as shown in FIG. 8. In that figure, the BeginExecute( . . . ) is called when all the required query parameters have been defined. The BeginExecute( . . . ) implementation requests the actual data, using GetProperty( . . . ) to get the query parameters, and then instantiates and fills a DataProviderObject-derived instance with the results. The instance is then assigned to the RESULT property to transfer the results back to the user interface.

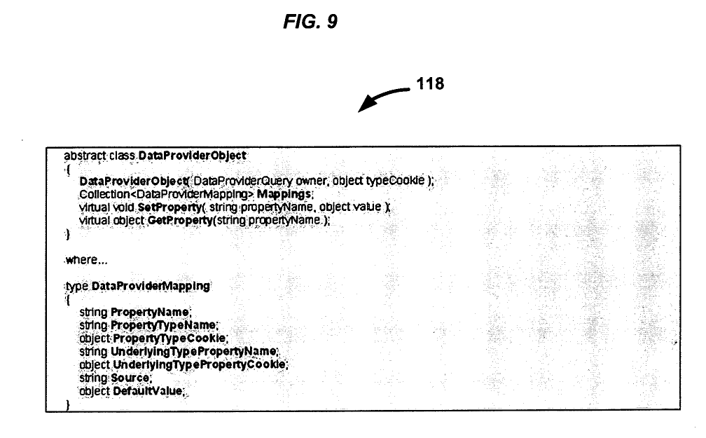

Referring to FIG. 9, the DataProviderObject class encapsulates an instance of a schema type defined in markup. On construction, the passed type cookie specifies the schema type the instance represents. This sets the set of properties the type has along with the associated mappings. The mappings are used to map the return data to property values. For example, a generic XML data provider implementation could interpret a mapping source property as an XPath, while a database data provider implementation may interpret a mapping source property as a table column name.

In a use of the arrangement, a data provider author implements a module that interacts with a data source, e.g., a local database, a REST XML query, and so on. The data provider is registered with the framework. The data provider author also exposes well-known query types, e.g., “artist” or “track” with different parameters to the query.

The markup author then, in addition to defining the data types such as “artist” or “track”, also defines queries that indicate to the framework that, in order to execute the query, the framework should communicate with the registered data provider of the same name. These queries are defined in the “Query” section of FIG. 4. The markup author also describes how to map the data from that data provider into the specified type, using the DataMapping section of the same figure. For example, a database query would have mapping between properties and columns in the database, while an XML REST query would map the same properties to an XPath using the source property (as shown in FIG. 4). These mappings are interpreted by the data provider and mapped accordingly in the data provider implementation.

The framework then communicates with the data provider using a dispatch mechanism as indicated in FIGS. 7-9. These interfaces encapsulate the interactions between the framework and the data provider, and in so doing they construct and execute queries, retrieve and set properties, and provide notification of changes in properties.

These types and queries are then accessible through the markup, e.g., the Splash markup. They can be used like any other type in markup, as indicated in FIG. 6. The markup author does not need to know about the specific implementation of the data provider or how the data is retrieved from the data source. These objects and types behave like any other objects and types in the markup, and as such they provide strongly typed property access that is compatible with the other framework facilities, and further provide property notifications that allow for dynamic updates to the visual structure on the screen when the data source is updated.

The above description provides an arrangement for extensible binding of graphical data within applications. Variations may also be apparent. For example, while the arrangement has been primarily described in the context of the Splash markup rendering framework, any suitable framework may be employed. Moreover, while the arrangement has been primarily described in the context of a personal computer, the arrangement may be used with any client device, including (but not limited to): desktop computers, laptop or notebook computers, handheld computers, personal digital assistants, smartphones, mobile phones, tablet computers, mainframe computers, or the like. Even more, while the arrangement has been described in the context of media player applications, the same may be applied to updates in any application. Implementation of the arrangement may be automatic or may be controlled by user input such as via a setup menu. While sourcing from remote data stores have been described, the arrangement may also be employed to source data from local data stores. While XML-REST and database type data sources or stores have been disclosed, the arrangement may be employed with any type of data source, including other XML formats and other web services. Other data providers might implement text files, .ini files, .csv files, .xls files, and the like. Any of these, as well as others, may be implemented and used in the arrangement.

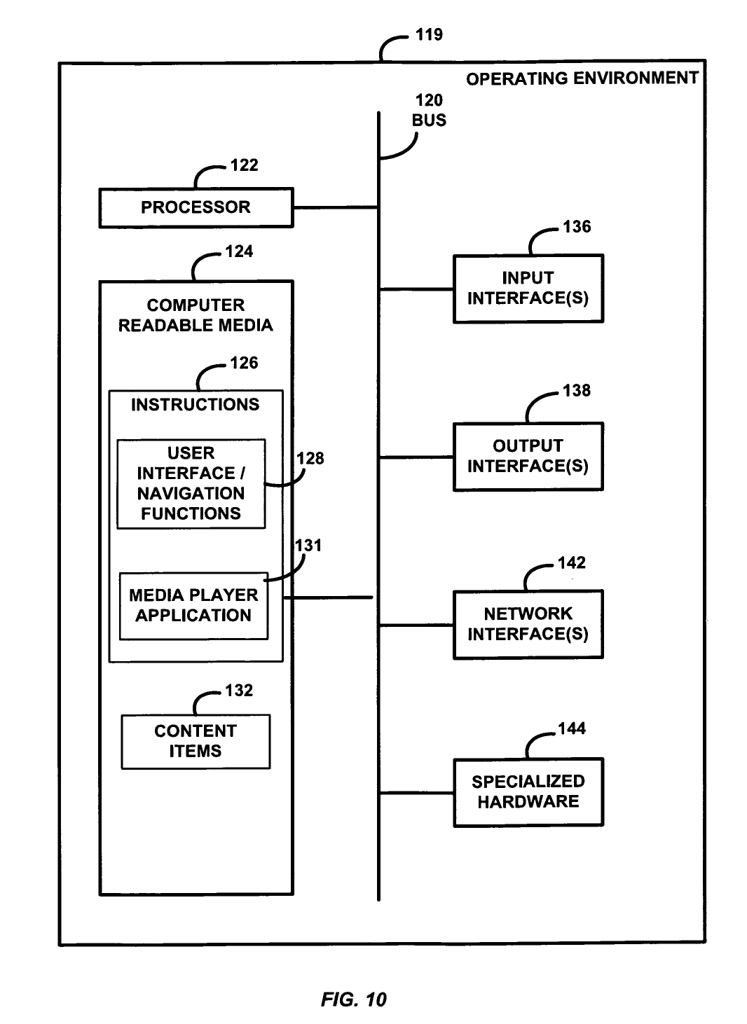

FIG. 10 is a block diagram of an exemplary configuration of an operating environment 119 (such as a client-side device or application or a networked server or service) in which all or part of the arrangement shown and discussed in connection with the figures may be implemented or used. Operating environment 119 is generally indicative of a wide variety of general-purpose or special-purpose computing environments, and is not intended to suggest any limitation as to the scope of use or functionality of the arrangements described herein.

As shown, operating environment 119 includes processor 122, computer-readable media 124, and computer-executable instructions 126. One or more internal buses 120 may be used to carry data, addresses, control signals, and other information within, to, or from operating environment 119 or elements thereof.

Processor 122, which may be a real or a virtual processor, controls functions of the operating environment by executing computer-executable instructions 126. The processor may execute instructions at the assembly, compiled, or machine-level to perform a particular process.

Computer-readable media 124 may represent any number and combination of local or remote devices, in any form, now known or later developed, capable of recording, storing, or transmitting computer-readable data, such as the above-noted computer-executable instructions 126, including user interface and navigation functions 128 and media player application 131, as well as content items 132. In particular, the computer-readable media 124 may be, or may include, a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a bubble memory; a cache memory; a core memory; a holographic memory; a memory stick; a paper tape; a punch card; or any combination thereof. The computer-readable media may also include transmission media and data associated therewith. Examples of transmission media/data include, but are not limited to, data embodied in any form of wireline or wireless transmission, such as packetized or non-packetized data carried by a modulated carrier signal.

Computer-executable instructions 124 represent any signal processing methods or stored instructions. Generally, computer-executable instructions 126 are implemented as software components according to well-known practices for component-based software development, and are encoded in computer-readable media. Computer programs may be combined or distributed in various ways. Computer-executable instructions 126, however, are not limited to implementation by any specific embodiments of computer programs, and in other instances may be implemented by, or executed in, hardware, software, firmware, or any combination thereof.

Input interface(s) 136 are any now-known or later-developed physical or logical elements that facilitate receipt of input to operating environment 119.

Output interface(s) 138 are any now-known or later-developed physical or logical elements that facilitate provisioning of output from operating environment 119.

Network interface(s) 142 represent one or more physical or logical elements, such as connectivity devices or computer-executable instructions, which enable communication between operating environment 119 and external devices or services, via one or more protocols or techniques. Such communication may be, but is not necessarily, client-server type communication or peer-to-peer communication. Information received at a given network interface may traverse one or more layers of a communication protocol stack.

Specialized hardware 144 represents any hardware or firmware that implements functions of operating environment 119. Examples of specialized hardware include encoders/decoders, decrypters, application-specific integrated circuits, clocks, and the like.

The methods shown and described above may be implemented in one or more general, multi-purpose, or single-purpose processors. Unless specifically stated, the methods described herein are not constrained to a particular order or sequence. In addition, some of the described methods or elements thereof can occur or be performed concurrently.

Functions/components described herein as being computer programs are not limited to implementation by any specific embodiments of computer programs. Rather, such functions/components are processes that convey or transform data, and may generally be implemented by, or executed in, hardware, software, firmware, or any combination thereof.

It will be appreciated that particular configurations of the operating environment may include fewer, more, or different components or functions than those described. In addition, functional components of the operating environment may be implemented by one or more devices, which are co-located or remotely located, in a variety of ways.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof

As it is understood that embodiments other than the specific embodiments described above may be devised without departing from the spirit and scope of the appended claims, it is intended that the scope of the subject matter herein will be governed by the following claims.

1. One or more tangible machine-readable media having a set of machine-readable instructions embodied thereon that when processed by a computing device cause it to perform a method of gathering information from multiple remote sources, the multiple remote sources collectively using at least two data storage conventions, the method comprising:
a. querying a remote source for information;
b. receiving information from the remote source;
c. comparing the received information to a plurality of stored data storage conventions;
d. determining which if any of the stored data storage conventions correspond to the received information; and
e. using the determined data storage convention, binding data in the information to a plurality of fields in an application.

2. The media of claim 1, in which the information corresponds to metadata about a media file.

3. The media of claim 1, in which the binding is performed when data in the plurality of fields are not otherwise being accessed.

4. The media of claim 1, in which the data storage convention corresponds to a database format.

5. The media of claim 1, in which the data storage convention corresponds to an XML format.

6. The media of claim 1, in which at least a portion of the querying, receiving, comparing, determining, and binding are performed by a data provider.

7. The media of claim 6, in which the data provider is a REST-based XML data provider that queries XML data from a REST service.

8. The media of claim 6, in which the data provider is a database data provider that queries database data from a local database.

9. The media of claim 6, further comprising registering the data provider.

10. One or more tangible machine-readable media having a set of machine-readable instructions embodied thereon that when processed by a computing device cause it to perform a method of abstracting information from an application such that a markup framework is separated from acquisition and processing of data from data sources, the method comprising:
a. describing a type definition;
b. processing the type definition by a framework such that a corresponding markup provides a type that is the same in behavior to at least one other type that is accessible from the markup;
c. implementing a data provider that interacts with a data store;
d. registering the data provider with the framework;
e. defining queries such that, to execute the query, the framework is caused to communicate with the registered data provider; and
f. mapping the results of the query from the registered data provider to a specified type.

11. The media of claim 10, in which the method further comprises:
a. querying a data store for information;
b. receiving information from the data store;
c. comparing the received information to a plurality of stored data storage conventions;
d. determining which if any of the stored data storage conventions correspond to the received information; and
e. using the determined data storage convention, binding data in the information to a plurality of fields in an application.

12. The media of claim 10, in which the framework is a Splash framework.

13. The media of claim 10, in which the information corresponds to metadata about a media file.

14. The media of claim 11, in which the binding is performed when data in the plurality of fields are not otherwise being accessed.

15. The media of claim 10, in which the data storage convention corresponds to a database format.

16. The media of claim 10, in which the data storage convention corresponds to an XML format.

17. The media of claim 11, in which at least a portion of the querying, receiving, comparing, determining, and binding are performed by a data provider.

18. The media of claim 10, in which the data provider is a REST-based XML data provider that queries XML data from a REST service.

19. The media of claim 10, in which the data provider is a database data provider that queries database data from a local database.

20. A method of gathering information about an item of content from one or more remote sources, the one or more remote sources employing different data storage conventions, comprising:
a. querying a remote source for data about a content item;
b. receiving a response to the query from the remote source;
c. analyzing the response to determine a data storage convention employed by the remote source; and
d. using the determined data storage convention, binding at least a portion of the received data to a plurality of fields pertaining to the content item in an application.
